(19) United States
(12) Patent Application Publication
(10) Pub. No.: US 2011/0247431 A1
(43) Pub. Date: Oct. 13, 2011

(54) Cartridge Flow Transducer

(76) Inventor: Daniel Ervin Moldenhauer, Milwaukee, WI (US)

(21) Appl. No.: 12/755,518

(22) Filed: Apr. 7, 2010

(51) Int. Cl. G01F 1/42

(52) U.S. Cl. 73/861.58

(57) ABSTRACT

There is provided a flow transducer and method to sense flow of a fluid. The flow transducer includes a housing defining an internal passage way therethrough. A flow rate apparatus is disclosed in the internal passageway. The proximity sensor is coupled to the housing, with the proximity sensor aligned radially with the flow rate apparatus. A pair of annular conductor-insulator assemblies are coupled to an outer surface of the housing, with each conductor in electrical communication with the proximity sensor. A cap is coupled to the housing and is configured to axially secure the conductor-insulator assemblies to the housing, with the cap defining an orifice axially aligned with the internal passageway. The proximity sensor is configured to produce an electrical signal as the flow rate apparatus rotates past the proximity sensor, the electrical signal corresponding to the flow of the fluid through the flow transducer.

### BACKGROUND OF THE INVENTION

### Field of the Invention

The present invention relates generally to transducers, and more particularly to a cartridge flow transducer configured for disposition in a fluid system component.

A transducer is a device that accepts an inputted energy in one form and produces an output of energy in some other form, with a known, fixed relationship between the input and the output. For example, a thermocouple converts heat energy into electrical energy with a fixed relationship relative to temperature. Another type of transducer converts fluid flow energy into electrical energy in a fixed relationship to determine the flow in a system to which the transducer is exposed.

One type of transducer typically is located spatially external to a host device from which the transducer is obtaining a signal. In such configuration, the transducer is exposed to the environment in which the host device is exposed with possible resulting damage from impacts, moisture, heat, etc. Such exposure of an externally positioned transducer can shorten its useful life thereby adding costs to the user of such transducer.

Another type of transducer is spatially configured integrally with a device. Such configuration eliminates the problems of the external mounted transducer however if the transducer experiences a malfunction, the entire device including the transducer has to be replaced. Such arrangement can be very expensive and typically the device is more expensive than the transducer which is contained in the device.

The cartridge flow transducer of the present disclosure avoids the various circumstances of an externally mounted transducer or an integrally contained transducer described above.

The cartridge flow transducer of the present disclosure must also be of construction which is both durable and long lasting, and it should also require little or no maintenance to be provided by the user throughout its operating lifetime. In order to enhance the market appeal of the apparatus of the present disclosure, it should also be of inexpensive construction to thereby afford it the broadest possible market. Finally, it is also an objective that all of the aforesaid advantages and objectives be achieved without incurring any substantial relative disadvantage.

### SUMMARY

The disadvantages and limitations of the background art discussed above are overcome by the present invention.

There is provided a flow transducer to sense flow of a fluid. The flow transducer includes a housing defining an internal passage way therethrough. A flow rate apparatus is disclosed in the internal passageway. The proximity sensor is coupled to the housing, with the proximity sensor aligned radially with the flow rate apparatus. A pair of annular conductor-insulator assemblies are coupled to an outer surface of the housing, with each conductor in electrical communication with the proximity sensor. A cap is coupled to the housing and is configured to axially secure the conductor-insulator assemblies to the housing, with the cap defining an orifice axially aligned with the internal passageway. The proximity sensor is configured to produce an electrical signal as the flow rate apparatus rotates past the proximity sensor, the electrical signal corresponding to the flow of the fluid through the flow transducer. In an exemplary embodiment of the flow transducer, each of the annular conductor-insulator assemblies defines an inside diameter corresponding to the outer surface of the outer housing portion of the housing and with each assembly including the conductor and an insulator. In another embodiment, the outer diameter of one of the conductor-insulator assemblies is less than the outer diameter of the other conductor-insulator assembly.

There is further provided a fluid system component. The fluid system component includes a component body including an inlet port and an outlet port, with the component body defining a conduit between the inlet and outlet ports. A flow transducer is configured for installation in the conduit, with the flow transducer including a housing defining an internal passageway therethrough. A flow rate apparatus is disposed in the internal passageway. The proximity sensor is coupled to the housing, with the proximity sensor aligned radially with the flow rate apparatus. A pair of annular conductor-insulator assemblies are coupled to an outer surface of the housing, with each conductor in electrical communication with the proximity sensor. A cap is coupled to the housing and configured to axially secure the conductor-insulator assemblies to the housing, with the cap defining an orifice aligned axially with the internal passageway. The proximity sensor is configured to produce an electrical signal as the flow rate apparatus rotates past the proximity sensor. The electrical signal corresponds to the flow of the fluid through the flow transducer and component body, and only the cap is exposed outside of the component body.

There is additionally provided a method to measure a flow of a fluid in a fluid system. The fluid system includes a fluid component defining an inlet port and an outlet port, with the fluid component defining a conduit between the inlet and outlet ports. Each port is configured to couple to the fluid system. The method includes providing a flow transducer configured for installation in the conduit. The flow transducer includes a housing defining an internal passageway therethrough. A flow rate apparatus is disposed in the internal passageway. A proximity sensor is coupled to the housing, with the proximity sensor aligned radially with the flow rate apparatus. A pair of annular conductor insulator assemblies are coupled to an outer surface of the housing, with each conductor in electrical communication with the proximity sensor. A cap is coupled to the housing and configured to axially secure the conductor insulator assemblies to the housing with the cap defining an orifice axially aligned with the internal passageway. The proximity sensor is configured to produce an electrical signal as the flow rate apparatus rotates past the proximity sensor. The electrical signal corresponds to the flow of the fluid through the flow transducer and component body. The method further includes installing the flow transducer in the conduit, wherein only the cap is exposed outside of the fluid component and wherein the flow transducer is in fluid communication with the fluid through the conduit. Coupling the flow transducer to a controller and obtaining a signal from the proximity sensor configured to provide a flow rate of the fluid. Transmitting the signal to the controller, wherein the flow rate of the fluid is manifested. In another embodiment, the proximity sensor is coupled to the inner housing portion of the housing, with the proximity sensor including two contacts with each contact positioned in corresponding relationship to the conductor of each of the conductor-insulator assemblies coupled to the outer housing portion of the housing. In an exemplary embodiment of the method to measure flow of fluid in a fluid system, the controller is a computer.

There is additionally provided a fluid system component. The fluid system component includes a component body including an inlet port and an outlet port, with the component body defining a conduit between the inlet and outlet ports. A flow transducer is configured for installation in the conduit, with the flow transducer comprising a housing defining an internal passageway therethrough. A flow rate apparatus is disposed in the internal passageway. A proximity sensor is coupled to the housing, with the proximity sensor aligned radially with the flow rate apparatus. A pair of annular conductor-insulator assemblies are coupled to an outer surface of the housing, with each conductor in electrical communication with the proximity sensor. A cap is coupled to the housing and configured to axially secure the conductor-insulator assemblies to the housing, with the cap defining an orifice axially aligned with the internal passageway. The fluid system component further includes an electronic module cavity defined in the component body, including a raceway in communication with the conduit. An electronic module is disposed in the electronic module cavity and coupled to the conductor-insulator assembly with a contact through the raceway. The electric module may be a microprocessor or an analog amplifier. The proximity sensor is configured to produce an electrical signal as the flow rate apparatus rotates past the proximity sensor with the electrical signal transmitted to the electronic module. The electronic signal corresponds to the flow of the fluid through the flow transducer and component body, and only the cap of the flow transducer is exposed outside of the component body.

There is additionally provided a flow transducer to sense flow of a fluid. The flow transducer includes a housing defining an internal passageway therethrough. A flow rate apparatus is disposed in a cavity defined in the housing and proximate the internal passageway. The flow rate apparatus includes a flow control subassembly and a particle counter axially aligned with the flow control sub assembly. The flow transducer further includes a plurality of annular conductor-insulator assemblies coupled to an outer surface of a housing, with each conductor in electrical communication with the flow rate apparatus. A cap is coupled to the housing and configured to axially secure the conductor-insulator assemblies to the housing. The cap defines an orifice axially aligned with the internal passageway. The flow rate apparatus is configured to produce an electrical signal as the fluid moves past the particle counter with the electrical signal corresponding to the flow of the fluid through the flow transducer. In one embodiment the particle counter includes a light emitter and a detector longitudinally aligned traverse to the internal passageway and configured to detect the fluid flow through the internal passageway. In another embodiment the particle counter further comprises a particle counter electronics module coupled to the light emitter, detector, and each of the conductor-insulator assemblies. The electronic module is configured to control the light emitter and detector and transmit the electrical signal.

The apparatus of the present disclosure is of a construction which is both durable and long lasting, and which will require little or no maintenance to be provided by the user throughout its operating lifetime. The apparatus of the present disclosure is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 is a cross-section illustration of an exemplary embodiment of a flow transducer including a flow rate apparatus and a proximity sensor coupled to a pair of annular conductor-insulator assemblies;

FIG. 2 is an exploded, perspective view of the flow transducer illustrated in FIG. 1;

FIG. 3 is a cross-section illustration of an exemplary embodiment of a fluid system component defining an inlet and outlet ports and further defining an internal passageway configured to receive the flow transducer illustrated in FIG. 1;

FIG. 4 is a cross-section illustration of an exemplary embodiment of a fluid system component defining an inlet and outlet ports and further defining an internal passageway configured to receive the flow transducer illustrated in FIG. 1, and further including an electronic module coupled to the flow transducer and a controller;

FIG. 5 is a cross-section illustration of an exemplary embodiment of a fluid system component defining an inlet and outlet ports coupled to a fluid system, the component further defining an internal passage configured to receive a flow transducer, with a proximity sensor in the flow transducer configured to couple directly with a data port coupled to the fluid system component; and

FIG. 6 is a cross-section illustration of an exemplary embodiment of a fluid system component defining inlet and outlet ports coupled to a fluid system, the component further defining an internal passageway configured to receive a flow transducer, with a proximity sensor coupled with an electronic module disposed in an electronic module cavity.

FIG. 7 is a schematic illustration of an exemplary embodiment of a flow transducer including a flow rate apparatus having a laser-type hydraulic particle counter.

### DETAILED DESCRIPTION OF THE EXEMPLARY EMBODIMENTS

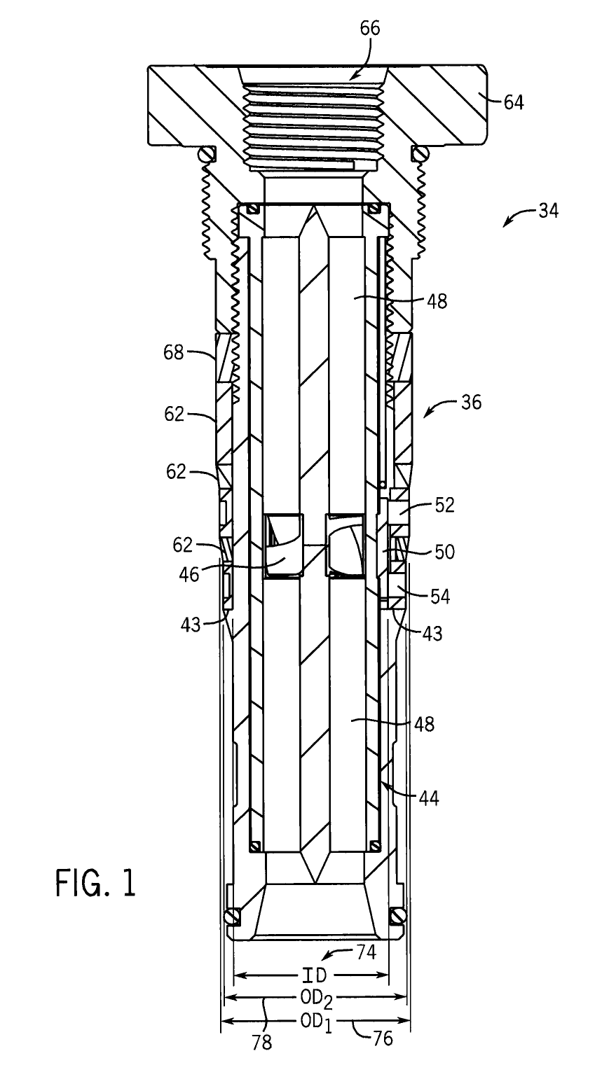

FIG. 1 illustrates a cross-section of an exemplary embodiment of a flow transducer 34. The flow transducer 34 includes a transducer housing 36 which defines an interior passageway 44. The passageway 44 extends longitudinally within the transducer housing 36. The transducer housing 36 includes an inner housing portion 38, and an outer housing portion 40. The inner housing portion 38 is configured to nest in the outer housing portion 40. The outer housing portion 40 also defines an outer surface 42.

The transducer housing 36 is configured with threading defined on one end of the housing 36. Such threading is used to secure a retainer nut 68 and a cap 64 to the transducer housing 36. The middle section of the transducer outer housing portion 40 defines the outer surface 42 which extends from the threading of the housing 37 to a land 43 defined by the transducer outer housing portion 40 and configured to support an annular conductor-insulator assembly.

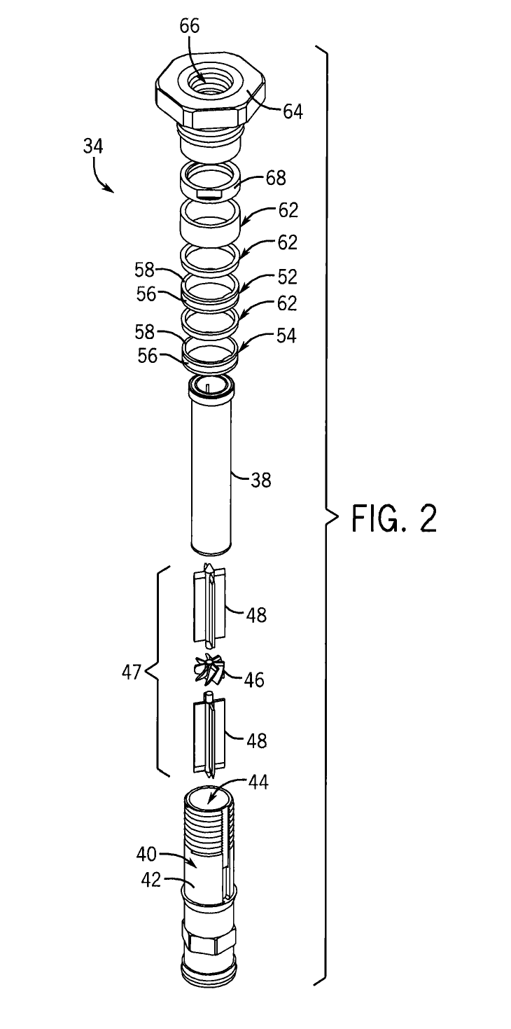

A flow rate apparatus 47 is disposed in the inner housing portion and is configured to react to the flow of fluid moving through the transducer housing 36. An exemplary embodiment of a flow rate apparatus 47 (See FIGS. 1 and 2) includes a turbine 46 rotatably mounted between two flow straighteners 48. The turbine typically includes a plurality of shaped blades, for example six, composed of a magnetic metal, for example steel. The turbine 46 rotates about a protrusion defined on one end of each flow straightener 48. Each flow straightener 48 is configured with a plurality of straight blades, for example four, with the end of each blade opposite the turbine 46 tapered to a beveled edge. The blades of the turbine 46 and the two flow straighteners 48 are configured to extend diagonally up to but not touching the inside wall of the inner housing portion 38 of the transducer housing 36, within user specified manufacturing tolerances.

A proximity sensor 50 is coupled to the housing 36, for example the outer surface 42 of the outer housing portion 40 and is not in fluid communication with the inner passageway 44. The proximity sensor 50 is coupled on the outer surface 42 and aligned radially with the flow rate apparatus 46, specifically the turbine 46 illustrated in the Figures in an exemplary embodiment. The sensor may be secured to the exterior of the transducer housing 36 by threading or other suitable fastening structure, for example adhesive or friction fit. The sensor may be for example a magnetic pick-up responsive to the turbine 46 blades.

The sensor is configured to measure a flow characteristic of a fluid in the fluid system F.S. to which the flow transducer 34 is exposed. The proximity sensor 50 generates a signal, as the turbine blades pass, corresponding to the flow rate of the fluid through the flow transducer 34.

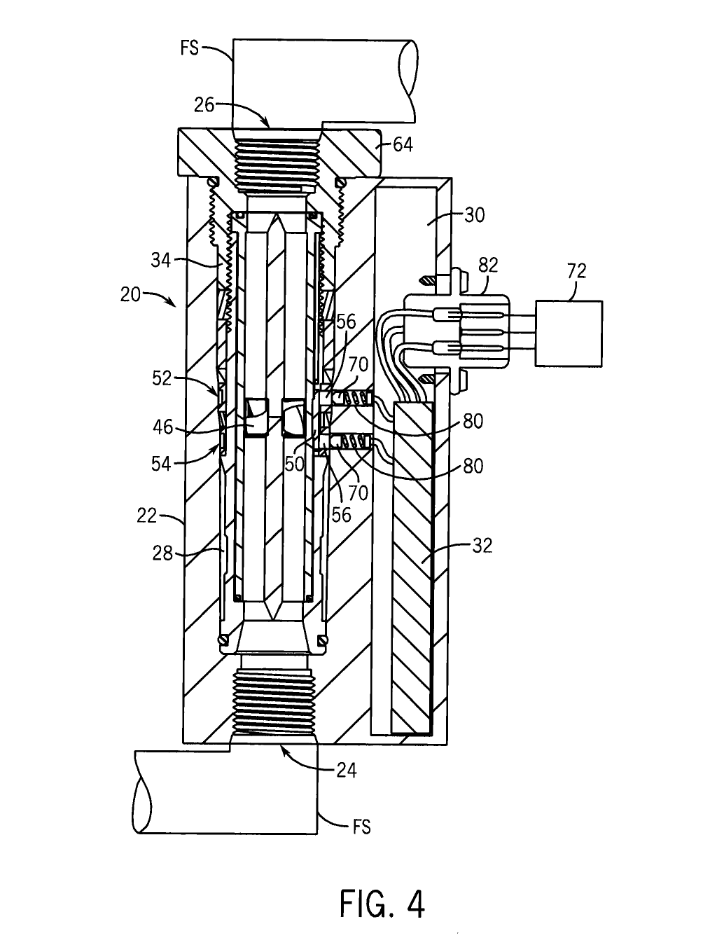

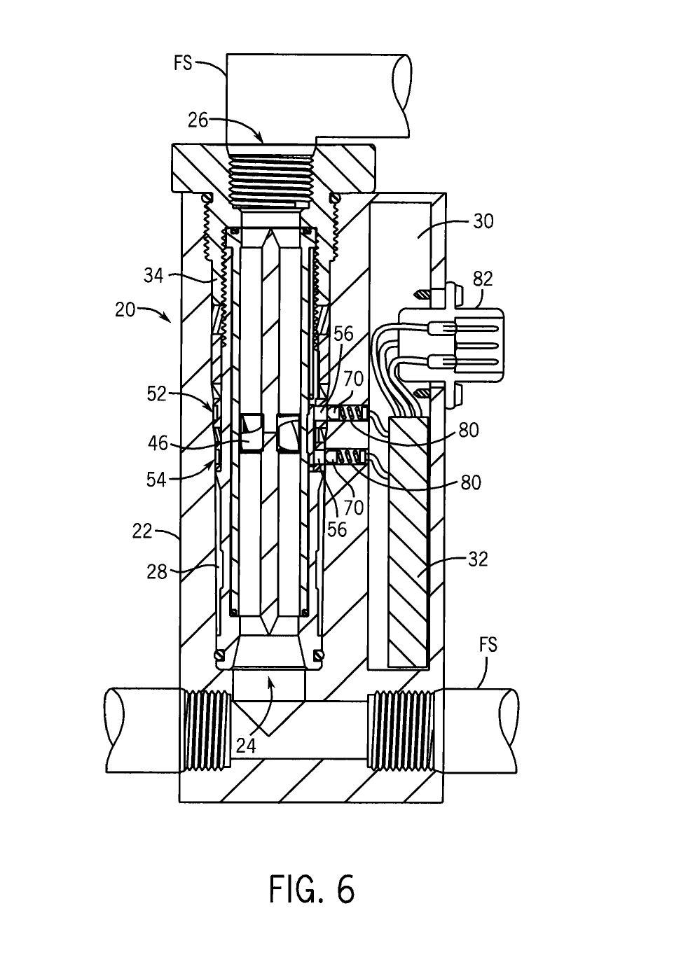

As illustrated in FIGS. 4 and 6, an electronic module 32 is in electric communication with the proximity sensor 50. The electronic module 32 may consist of one of an analog amplifier, a differential voltage amplifier, a calibration circuit, an output driver, and digital electronics, for example a microprocessor and a universal serial bus transceiver.

A cap 64 is coupled to the threaded portion of the transducer housing 36 (See FIG. 1). The cap 64 is also configured to seal against the inner housing portion 38 of the transducer housing 36 and is secured to the housing by the appropriate threading. As illustrated in FIGS. 1 and 2 the cap 64 defines an orifice 66 axially aligned with the internal passage 44. The orifice 66 may be threaded to allow coupling to the fluid system F.S. The cap 64 is also configured to axially secure the conductor-insulator assemblies to the housing 36 in cooperation with the retainer nut 68. (The conductor-insulator assemblies will be described below.)

A conductor-insulator assembly 52 is coupled to the outer surface 42 of the transducer housing 36. The conductor-insulator assembly 52 includes an insulator 58 and a conductor 56. The conductor-insulator assembly 52 is annular in shape with its inside diameter 74 sized to engage the outer surface 42 of the transducer housing 36. The insulator 58 is U-shaped, in cross section, forming a channel in which the annular conductor 56 is disposed. The insulator insulates the conductor 56 from the transducer housing 36.

As illustrated in the Figures, additional conductor-insulator assemblies can be installed on the transducer housing 36 with each subsequent conductor-insulator assembly having an outside diameter less than the outer diameter of the previous conductor-insulator assembly. As illustrated in FIG. 1, the conductor-insulator assembly 52 is closest to the threaded section of the transducer housing 36. That conductor-insulator assembly 52 has an outside diameter 76. A second conductor-insulator assembly 54 is positioned a distance from the first conductor-insulator assembly 52 by a spacer 62. The second conductor-insulator assembly 54 defines an outside diameter 78 that is less than the outside diameter 76 of the first conductor-insulator assembly 52. The retainer nut 68 is coupled to the flow transducer housing 36 and is configured to axially secure the conductor-insulator assemblies, including assemblies 52, 54, to the flow transducer housing 36. Additional spacers may be used to configure the flow transducer 34. For example, FIG. 1 illustrates two additional spaces 62 mounted between the retainer nut 68 and the first insulator-conductor assembly 52. The spacers 62 may be of different lengths and shapes, but must maintain an inside diameter corresponding to the outer surface 42.

It should be understood that any number of conductor-insulator assemblies can be disposed on the transducer housing as determined by a user with appropriate sizing of the insulator and conductors. All of the conductor-insulator assemblies are annular in shape, with the same inside diameter (ID) equal to the outside diameter of the flow transducer housing 36 outer surface 42. The stepped configuration of the various conductor-insulator assemblies as illustrated in the Figures provides isolation of signal flowing through the various conductors. The various conductors 56 in the conductor-insulator assemblies 52, 54 provide electrical connection for the signal generated by the passage of the turbine 46 blades past the proximity sensor. As illustrated in FIG. 1, the proximity sensor 50 is coupled to at least two of the conductors 56. An alternative exemplary configuration is provided with three conductor-insulator assemblies with one assembly providing Sig⁺ and the second one providing a Sig and the third providing an auxiliary signal. In some circumstances, the flow transducer 34 can be provided with a single conductor-insulator assembly and using the flow transducer housing 36 itself as a conductor in the system.

As illustrated in FIG. 1, appropriate O-ring seals are provided at specific locations along the exterior of the flow transducer housing 36 as well as in the interior passageway 44 to fluidly seal the flow transducer from pressurized fluid being measured as the atmospherically pressurized electrical contact region of the insulator-conductor assemblies 52, 54. The O-rings are composed of appropriate materials that are suitable for the specific application. It is also contemplated that other types of sealing systems, such as a gel or gasket material can be used as determined by a user. It is also contemplated that the transducer housing 36, retainer nut 92 and cap 78 are composed of suitable material such as aluminum, stainless steel, and steel or combination of the same as deemed appropriate by the user for a specific application. Other materials may be used, such as engineered plastic or composite materials, configured appropriately for the intended application.

The cartridge-type flow transducer 34 is configured for installation in a fluid system component 20. The fluid system component 20 typically is installed and coupled into a fluid system F.S. The fluid system component 20 may be a device for measuring a characteristic of the fluid flowing in the fluid system F.S. or it may be a part of a control device such as a valve.

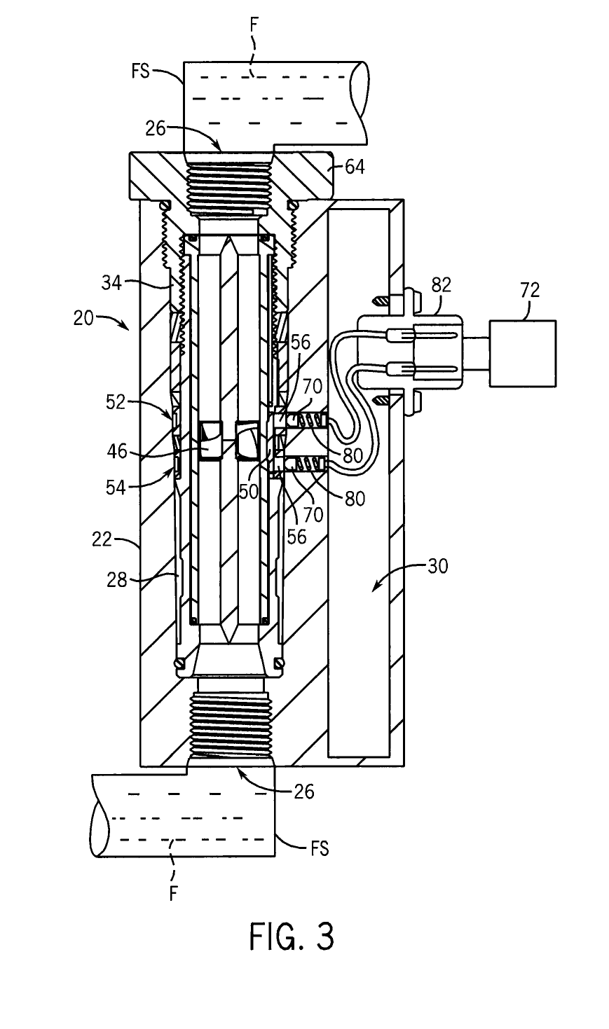

FIGS. 3-6 illustrate variants of a fluid system component 20 which include a cartridge-type flow transducer 34. The fluid system component 20 includes a component body 22 that defines an inlet port 24 and an outlet port 26 and further defining a conduit 28 between the inlet 24 and outlet 26 ports. The conduit 28 is in fluid communication with the fluid system F.S.

The conduit 28 is configured to receive a cartridge-type flow transducer 34. The fluid system component 20 further defines an electronic module cavity 30 including a raceway 80 in communication with the conduit 28. As illustrated in FIGS. 3-6, two raceways 80 are defined in the component body of 22. The raceways 80 provide access for wires and contacts 70 between devices in the electronic module cavity 30 and the conductor-insulator assemblies 52, 54 on the flow transducer housing 36.

With the cartridge-type flow transducer 34 installed in the conduit 28 of the component body 22 only the cap 64 is exposed outside the component body 22. It is also contemplated that the conduit 28 can be configured so that the cap 64 of the flow transducer 34 is also installed in the cartridge-type component body 22 so that a top surface of the cap 64 is flush with a surface of the component body 22 of the fluid system component 20.

As illustrated in FIG. 3, an electrical contact 70 is in physical and electrical contact with the conductor 56 of the conductor-insulator assembly on the flow transducer 34. The contact 70 is configured for installation in the raceway 80 defined in the component body 22 and may be biased by an appropriate spring to maintain physical contact with the conductor 56 of a conductor-insulator assembly of the fluid transducer 34. As illustrated in FIG. 3, the electrical contact 70 includes a wire coupled to a data port 82 defined in the component body 22. As further illustrated in FIG. 3, the data port 82 is coupled to the component body 22 with appropriate wiring passing through the electronic module cavity 30. The data port 82 may be formed integrally with the component body 22 or coupled to the component body 22 with appropriate fastener, for example screws or a snap fit apparatus.

Appropriate data signals are transmitted through the data port 82 to and from the flow transducer 34 through the conductors 56 of each of a conductor-insulator assembly mounted on the flow transducer housing 36. A signal from the proximity sensor 50 is transmitted to the data port 82 through the conductor 56 and electrical contact 70 as described above.

In another variant of the fluid system component 20, an electronic module 32 is installed in the electronic module cavity 30 (See FIGS. 4 and 6). The electronic module 32 can be a controller, for example a micro processor, or an analog amplifier and is in electrical contact with the data port 82 and the conductor 56 of each of the conductor-insulator assemblies 52, 54 mounted on the flow transducer 34 through a raceway 80 defined in the component body 22.

In another embodiment, as illustrated in FIG. 4, the proximity sensor 50 of the flow transducer is coupled to the data port 82 through the electronic module 32 and wiring passing through the electronic module cavity 30. In such circumstance, a controller 72, for example a computer or other data powered device is coupled to the data port 82 external to the fluid system component 20.

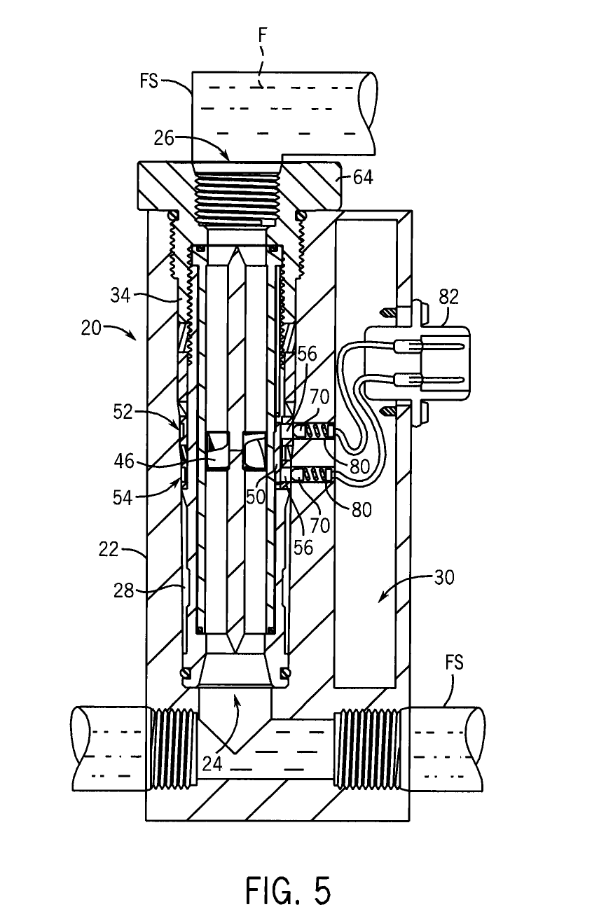

Several types of electrical and physical connections of the fluid transducer 34 in the dual port body 22 of the fluid system component 20 as described with respect to FIGS. 3 and 4 are similarly applicable to the multi-port fluid system component 20 illustrated in FIGS. 5 and 6.

In each of the multi-port and dual port fluid system component 20 as illustrated in FIGS. 3-6, the fluid transducer 34 is used to measure a characteristic of a fluid flow in the fluid system F.S. The fluid system F.S. includes a fluid component 20 coupled to the fluid system F.S. In operation, an operator would install the cartridge-type flow transducer 34 into the conduit 28 defined in the component body 22 of the fluid system component 20. Because of the annular conductor-insulator assemblies 52, 54 on the flow transducer housing 36 a specific or keyed orientation of the flow transducer 34 is not required. However, it should be understood that a specific or keyed or indexed orientation may be provided as determined by a user of the flow transducer 34 and the fluid system component 20. Further, because of the different outside diameter configurations relative to each of the conductor-insulator assemblies specific electrical contacts for power and data can be maintained in the fluid system component.

With the flow transducer 34 installed in the fluid system component 20 only the cap 64 is exposed outside of the component body 22. Therefore, the sensor and electronics associated with the flow transducer 34 is not exposed to environmental conditions to which the fluid system component 20 is subject. In other words, the flow transducer 34 would not be damaged by chemicals, moisture or physical abuse to which conventional transducers typically are exposed. Such configuration as disclosed herein provided mechanical ruggedness as well as environmental ruggedness. The flow transducer 34 is also electrically rugged since the transducer has significantly high noise immunity because it is located within the metallic body of the fluid system component 20. Accordingly, transmissions such as radio frequency interference through the component body 22 is virtually eliminated.

If the flow transducer 34 experiences a malfunction of any sort, it can easily be replaced by simply unthreading it from the component body 22 and replacing it with an appropriate substitute. It is not necessary to replace the entire fluid system component 20 nor rewire the transducer to the data port 82 since the alignment of the various electrical contacts 70 is maintained by the orientation of the conductor-insulator assemblies 52, 54, etc. Further, the various sealing components associated with the flow transducer 34 maintain the hydraulic integrity of the fluid system component 20 while providing for appropriate fluid communication of the flow transducer 34 in the fluid system F.S.

Signals to and from the fluid transducer 34 are transmitted through the data port 82 defined in or coupled to the component body 22. Such configuration and capability allows the flow transducer 34 and its components to be reconfigured as necessary and/or to provide appropriate control signals to other devices.

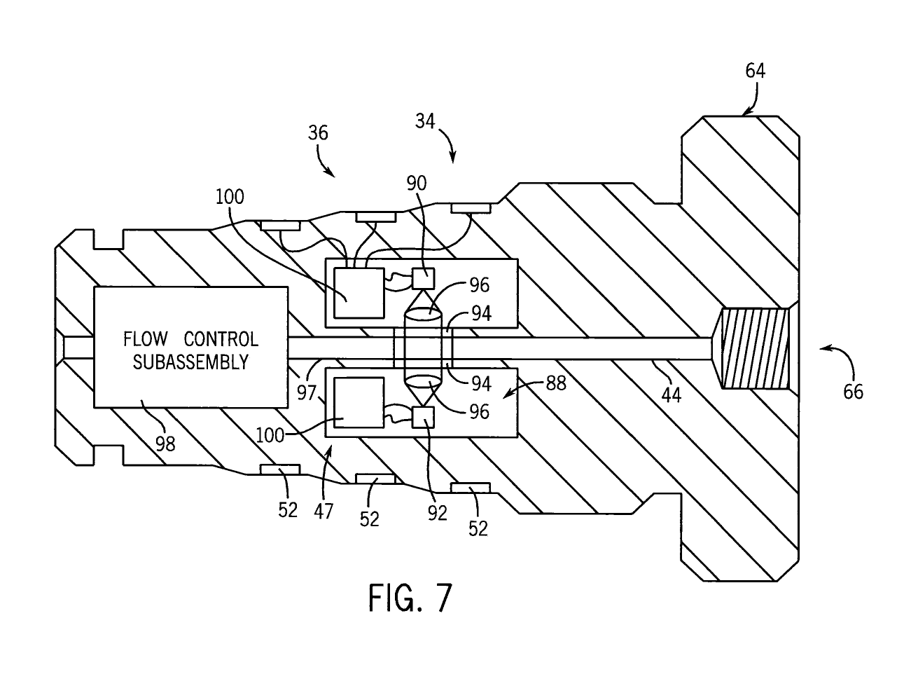

Referring to FIG. 7, there is illustrated a schematic diagram of an exemplary embodiment of a flow transducer 34 including a flow rate apparatus 47 having a laser-type hydraulic particle counter. The flow transducer 34 includes the transducer housing 36 similar to the housing described above which includes a plurality of annular conductor-insulator assemblies 52. Cap 64 is coupled to the housing 36 and is configured to axially secure the conductor-insulator assemblies 52 to the housing 36. The cap 64 also defines an orifice 66 axially aligned with the internal passageway 44 through which the fluid to be measured flows. The transducer housing 36 includes a flow control subassembly 98 for example a hydraulic flow control valve. The hydraulic flow control valve is used to maintain a reasonably steady flow of fluid through the flow rate apparatus 47 regardless of the pressure of the fluid flowing through the flow transducer 34. If the fluid flow is too high the detection accuracy is reduced and if the fluid flow is too low, it takes more sampling time to achieve a given accuracy of the fluid flow.

The transducer housing 36 includes a flow rate apparatus 47 disposed in a particle counter cavity 88. The particle counter cavity 88 can be a defined annular cavity within the transducer housing 36 or it can be a pair of cavities with one cavity on each side of the interior passageway 44 through which the fluid flows. In the particle counter cavity 88 particle counter electronics 100 are positioned and coupled electrically and physically to the plurality of conductor-insulator assemblies. The particle counter electronics 100 controls the flow rate apparatus 47.

The transducer housing 36 further defines a traverse bore 97 in optical communication with the particle counter cavity 88. As illustrated in FIG. 7, a pair of glass windows 94 are positioned within the traverse bore 97 and define a portion of the side wall defining the interior passageway 44. The glass windows 94 allow light to pass from the light emitter and the detector 92 which are longitudinally aligned traverse to the interior passageway 44 and configured to detect and measure the fluid flow through the passageway 44. A pair of lenses 96 are positioned on either side of the interior passageway 44 and aligned longitudinally with the light emitter 90 and the detector 92. The light emitter 90 can be for example a laser and as illustrated in FIG. 7 it can be a light emitting diode laser. The lenses 96 are configured to shape the light emanating from the light emitter 90 to the detector 92 through the glass windows 94 and the traverse bore 97 to detect and measure the fluid flow through the internal passage 44 of the flow transducer 34.

It is also contemplated that the flow rate apparatus 47 may include non-laser based design and may also include a laser emitter that measures reflective light instead of transmitted light as illustrated in FIG. 7.

The particle counter electronics 100 provides power and data through the plurality of annular conductor-insulator assemblies 52 and can tune the light emitter 90 and detector 92 as required by user of the flow transducer 34.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of a cartridge-type flow transducer has been shown and described with reference to particular embodiments and applications thereof, it has been presented for purposes of illustration and description and is not intended to be exhaustive or to limit the disclosure to the particular embodiments and applications disclosed. It will be apparent to those having ordinary skill in the art that a number of changes, modifications, variations, or alterations to the flow transducer and fluid system component as described herein may be made, none of which depart from the spirit or scope of the present disclosure. The particular embodiments and applications were chosen and described to provide the best illustration of the principles of the disclosure and its practical application to thereby enable one of ordinary skill in the art to utilize the fluid transducer in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. A flow transducer to sense flow of a fluid comprising:
a housing defining an internal passageway there through;
a flow rate apparatus disposed in the internal passageway;
a proximity sensor coupled to the housing, with the proximity sensor aligned radially with the flow rate apparatus;
a pair of annular conductor-insulator assemblies coupled to an outer surface of the housing, with each conductor in electrical communication with the proximity sensor; and
a cap coupled to the housing and configured to axially secure the conductor-insulator assemblies to the housing, with the cap defining an orifice axially aligned with the internal passageway;
wherein the proximity sensor is configured to produce an electrical signal as the flow rate apparatus rotates past the proximity sensor, the electrical signal corresponding to the flow of the fluid through the flow transducer.

2. The flow transducer of claim 1, wherein the housing includes an inner housing portion nested in an outer housing portion.

3. The flow transducer of claim 2, wherein the outer surface is defined on the outer housing portion of the housing.

4. The flow transducer of claim 1, wherein each of the annular conductor-insulator assemblies define an inside diameter corresponding to the outer surface of the outer housing portion of the housing and with each assembly including the conductor and an insulator.

5. The flow transducer of claim 4, wherein the outer diameter of one of the conductor-insulator assemblies is less than the outer diameter of the other conductor-insulator assembly.

6. The flow transducer of claim 4, wherein the insulator is coupled to the conductor, and wherein each insulator is configured in an U-shaped cross-section defining a channel in which the conductor is disposed.

7. The flow transducer of claim 6, wherein the insulator of the conductor-insulator assembly is configured to insulate the conductor electrically from the transducer housing.

8. The flow transducer of claim 1, including a retainer nut coupled to the housing between the cap and the conductor-insulator assemblies and configured to axially secure the conductor-insulator assemblies to the housing.

9. The flow transducer of claim 1, wherein the proximity sensor is coupled to the inner housing portion of the housing, the proximity sensor including two contacts with each contact positioned in corresponding relationship to the conductor of each of the conductor-insulator assemblies coupled to the outer housing portion of the housing.

10. A fluid system component comprising:
a component body including an inlet port and an outlet port, with the component body defining a conduit between the inlet and outlet ports; and
a flow transducer configured for installation in the conduit, with the flow transducer comprising:
a housing defining an internal passageway there through;
a flow rate apparatus disposed in the internal passageway;
a proximity sensor coupled to the housing, with the proximity sensor aligned radially with the flow rate apparatus;
a pair of annular conductor-insulator assemblies coupled to an outer surface of the housing, with each conductor in electrical communication with the proximity sensor; and
a cap coupled to the housing and configured to axially secure the conductor-insulator assemblies to the housing, with the cap defining an orifice axially aligned with the internal passageway;
wherein the proximity sensor is configured to produce an electrical signal as the flow rate apparatus rotates past the proximity sensor, the electrical signal corresponding to the flow of the fluid through the flow transducer and component body, and only the cap is exposed outside of the component body.

11. The fluid system component of claim 10, wherein the housing includes an inner housing portion nested in an outer housing portion.

12. The fluid system component of claim 11, wherein the outer surface is defined on the outer housing portion of the housing.

13. The fluid system component of claim 10, wherein each of the annular conductor-insulator assemblies define an inside diameter corresponding to the outer surface of the outer housing portion of the housing and with each assembly including the conductor and an insulator.

14. The fluid system component of claim 13, wherein the outer diameter of one of the conductor-insulator assemblies is less than the outer diameter of the other conductor-insulator assembly.

15. The fluid system component of claim 13, wherein the insulator is coupled to the conductor, and wherein each insulator is configured in an U-shaped cross-section defining a channel in which the conductor is disposed.

16. The fluid system component of claim 15, wherein the insulator of the conductor-insulator assembly is configured to insulate the conductor electrically from the transducer housing.

17. The fluid system component of claim 10, including a retainer nut coupled to the housing between the cap and the conductor-insulator assemblies and configured to axially secure the conductor-insulator assemblies to the housing.

18. The fluid system component of claim 10, wherein the proximity sensor is coupled to the inner housing portion of the housing, the proximity sensor including two contacts with each contact positioned in corresponding relationship to the conductor of each of the conductor-insulator assemblies coupled to the outer housing portion of the housing.

19. A method to measure a flow of a fluid in a fluid system, the fluid system including a fluid component defining an inlet port and an outlet port, with the fluid component defining a conduit between the inlet and outlet ports, with each port configured to couple to the fluid system, the method comprising:
providing a flow transducer configured for installation in the conduit, with the flow transducer comprising:
a housing defining an internal passageway there through;
a flow rate apparatus disposed in the internal passageway;
a proximity sensor coupled to the housing, with the proximity sensor aligned radially with the flow rate apparatus;
a pair of annular conductor-insulator assemblies coupled to an outer surface of the housing, with each conductor in electrical communication with the proximity sensor; and
a cap coupled to the housing and configured to axially secure the conductor-insulator assemblies to the housing, with the cap defining an orifice axially aligned with the internal passageway;
wherein the proximity sensor is configured to produce an electrical signal as the flow rate apparatus rotates past the proximity sensor, the electrical signal corresponding to the flow of the fluid through the flow transducer and component body;
installing the flow transducer in the conduit, wherein only the cap is exposed outside of the fluid component and wherein the flow transducer is in fluid communication with the fluid through the conduit;
coupling the flow transducer to a controller;
obtaining a signal from the proximity sensor configured to provide a flow rate of the fluid; and
transmitting the signal to the controller, wherein the flow rate of the fluid is manifested.

20. The method to measure a flow of claim 19, wherein the housing includes an inner housing portion nested in an outer housing portion.

21. The method to measure a flow of claim 20, wherein the outer surface is defined on the outer housing portion of the housing.

22. The method to measure a flow of claim 19, wherein each of the annular conductor-insulator assemblies define an inside diameter corresponding to the outer surface of the outer housing portion of the housing and with each assembly including the conductor and an insulator.

23. The method to measure a flow of claim 22, wherein the outer diameter of one of the conductor-insulator assemblies is less than the outer diameter of the other conductor-insulator assembly.

24. The method to measure a flow of claim 22, wherein the insulator is coupled to the conductor, and wherein each insulator is configured in an U-shaped cross-section defining a channel in which the conductor is disposed.

25. The method to measure a flow of claim 24, wherein the insulator of the conductor-insulator assembly is configured to insulate the conductor electrically from the transducer housing.

26. The method to measure a flow of claim 19, including a step of coupling a retainer nut to the housing between the cap and the conductor-insulator assemblies with the retainer nut configured to axially secure the conductor-insulator assemblies to the housing.

27. The method to measure a flow of claim 19, wherein the proximity sensor is coupled to the inner housing portion of the housing, the proximity sensor including two contacts with each contact positioned in corresponding relationship to the conductor of each of the conductor-insulator assemblies coupled to the outer housing portion of the housing.

28. The method of claim 19, wherein the controller is a computer.

29. A fluid system component comprising:
a component body including an inlet port and an outlet port, with the component body defining a conduit between the inlet and outlet ports;
a flow transducer configured for installation in the conduit, with the flow transducer comprising:
a housing defining an internal passageway there through;
a flow rate apparatus disposed in the internal passageway;
a proximity sensor coupled to the housing, with the proximity sensor aligned radially with the flow rate apparatus;
a pair of annular conductor-insulator assemblies coupled to an outer surface of the housing, with each conductor in electrical communication with the proximity sensor; and
a cap coupled to the housing and configured to axially secure the conductor-insulator assemblies to the housing, with the cap defining an orifice axially aligned with the internal passageway;
an electronic module cavity defined in the component body, including a raceway in communication with the conduit; and
an electronic module disposed in the electronic module cavity and coupled to the conductor-insulator assembly with a contact through the raceway;
wherein the proximity sensor is configured to produce an electrical signal as the flow rate apparatus rotates past the proximity sensor with the electrical signal transmitted to the electronic module, the electrical signal corresponding to the flow of the fluid through the flow transducer and component body, and only the cap is exposed outside of the component body.

30. The fluid system component of claim 29, wherein the housing includes an inner housing portion nested in an outer housing portion.

31. The fluid system component of claim 30, wherein the outer surface is defined on the outer housing portion of the housing.

32. The fluid system component of claim 29, wherein each of the annular conductor-insulator assemblies define an inside diameter corresponding to the outer surface of the outer housing portion of the housing and with each assembly including the conductor and an insulator.

33. The fluid system component of claim 32, wherein the outer diameter of one of the conductor-insulator assemblies is less than the outer diameter of the other conductor-insulator assembly.

34. The fluid system component of claim 32, wherein the insulator is coupled to the conductor, and wherein each insulator is configured in an U-shaped cross-section defining a channel in which the conductor is disposed.

35. The fluid system component of claim 34, wherein the insulator of the conductor-insulator assembly is configured to insulate the conductor electrically from the transducer housing.

36. The fluid system component of claim 29, including a retainer nut coupled to the housing between the cap and the conductor-insulator assemblies and configured to axially secure the conductor-insulator assemblies to the housing.

37. The fluid system component of claim 29, wherein the proximity sensor is coupled to the inner housing portion of the housing, the proximity sensor including two contacts with each contact positioned in corresponding relationship to the conductor of each of the conductor-insulator assemblies coupled to the outer housing portion of the housing.

38. The fluid system component of claim 29, including a data port coupled to the component body, with the data port in electric communication with the electronic module, wherein data is transmitted to and from the electronic module and wherein the electronic module is reconfigurable through the data port.

39. The fluid system component of claim 38, wherein the electronic module is an analog amplifier.

40. A flow transducer to sense flow of a fluid comprising:
a housing defining an internal passageway there through;
a flow rate apparatus disposed in a cavity defined in the housing and proximate the internal passageway, the flow rate apparatus comprising:
a flow control subassembly and
a particle counter axially aligned with the flow control subassembly;
a plurality of annular conductor-insulator assemblies coupled to an outer surface of the housing, with each conductor in electrical communication with the flow rate apparatus; and
a cap coupled to the housing and configured to axially secure the conductor-insulator assemblies to the housing, with the cap defining an orifice axially aligned with the internal passageway;
wherein the flow rate apparatus is configured to produce an electrical signal as the fluid moves past the particle counter, the electrical signal corresponding to the flow of the fluid through the flow transducer.

41. The flow transducer of claim 40, the particle counter comprising a light emitter and a detector longitudinally aligned transverse to the internal passageway and configured to detect the fluid flow through the passageway.

42. The flow transducer of claim 41, the particle counter further comprising a particle counter electronics module coupled to the light emitter, detector, and each of the conductor-insulator assemblies, the electronic module configured to control the light emitter and detector and transmit the electrical signal.

43. The flow transducer of claim 40, wherein each of the annular conductor-insulator assemblies define an inside diameter corresponding to the outer surface of the outer housing portion of the housing and with each assembly including the conductor and an insulator.

44. The flow transducer of claim 43, wherein the outer diameter of one of the conductor-insulator assemblies is less than the outer diameter of another conductor-insulator assembly.

45. The flow transducer of claim 43, wherein the insulator is coupled to the conductor, and wherein each insulator is configured in an U-shaped cross-section defining a channel in which the conductor is disposed.

46. The flow transducer of claim 45, wherein the insulator of the conductor-insulator assembly is configured to insulate the conductor electrically from the transducer housing.

47. The flow transducer of claim 40, including a retainer nut coupled to the housing between the cap and the conductor-insulator assemblies and configured to axially secure the conductor-insulator assemblies to the housing.
